(19) United States
(12) Patent Application Publication
(10) Pub. No.: US 2026/0285314 A1
(43) Pub. Date: Sep. 24, 2026

(54) VEHICLE

(71) Applicant: HONDA MOTOR CO., LTD., Tokyo (JP)

(72) Inventor: Yuzo OKUBO, Tokyo (JP)

(73) Assignee: HONDA MOTOR CO., LTD., Tokyo (JP)

(21) Appl. No.: 19/570,196

(22) Filed: Mar. 18, 2026

(30) Foreign Application Priority Data
Mar. 19, 2025 (JP) 2025-044453

(51) Int. Cl. B60W 30/18; B60W 10/08; B60W 10/184

(52) U.S. Cl. CPC B60W 30/18127; B60W 10/08; B60W 10/184; B60W 2520/26; B60W 2520/28; B60W 2720/106

(57) ABSTRACT

A vehicle includes: an electric motor configured to perform regenerative braking of a wheel; a braking device configured to perform friction braking of the wheel; a required deceleration acquirer configured to acquire a required deceleration of the wheel; a wheel speed acquirer configured to acquire a rotational speed of the wheel; and a control device configured to control braking amounts of the electric motor and the braking device. The control device is configured to perform braking of the wheel based on the required deceleration, the rotational speed, and a slip amount of the wheel.

This application is based upon and claims the benefit of priority from prior Japanese patent application No. 2025-044453, filed on Mar. 19, 2025, the entire contents of which are incorporated herein by reference.

### TECHNICAL FIELD

The present disclosure relates to a vehicle including an electric motor that performs regenerative braking of wheels and a braking device that performs friction braking of the wheels.

### BACKGROUND ART

In recent years, as a specific countermeasure against global climate change, efforts toward realization of a low-carbon society or a decarbonized society are activated. A reduction in CO₂ emission amount and an improvement in energy efficiency are also required for vehicles such as automobiles, and research and development have been conducted on electrification techniques for battery electric vehicles and hybrid electrical vehicles, for example.

JP2001-008306A discloses a technique in which braking is performed only by a regenerative braking force when a maximum regenerative braking force is larger than a required braking force, and regenerative braking and friction braking by a disc brake are performed when the required braking force is larger than the maximum regenerative braking force.

### SUMMARY OF INVENTION

However, a case where a slip occurs at a wheel has not been sufficiently studied, and there is room for improvement in this point.

Aspects of the present disclosure relate to a vehicle capable of appropriately controlling regenerative braking and friction braking of a wheel while satisfying a required deceleration even when the wheel slips.

According to an aspect of the present disclosure, there is provided a vehicle including:
an electric motor configured to perform regenerative braking of a wheel;
a braking device configured to perform friction braking of the wheel;
a required deceleration acquirer configured to acquire a required deceleration of the wheel;
a wheel speed acquirer configured to acquire a rotational speed of the wheel; and
a control device configured to control braking amounts of the electric motor and the braking device, in which
the control device is configured to perform braking of the wheel based on the required deceleration, the rotational speed, and a slip amount of the wheel.

According to aspects of the present disclosure, it is possible to provide a vehicle capable of appropriately controlling regenerative braking and friction braking of a wheel while satisfying a required deceleration even when the wheel slips. This further contributes to improvement in energy efficiency.

### BRIEF DESCRIPTION OF DRAWINGS

Exemplary embodiment(s) of the present invention will be described in detail based on the following figures, wherein

FIG. 1 is a diagram illustrating a schematic configuration of a vehicle according to the present embodiment;

FIG. 2 is a block diagram illustrating a functional configuration of a control device mounted on the vehicle of the present embodiment;

FIG. 3 is a table illustrating slip control priority according to a vehicle speed and a required deceleration;

FIG. 4 is a flowchart illustrating an example of control performed by the control device of the present embodiment;

FIG. 5 is a flowchart for complementing the flowchart illustrated in FIG. 4;

FIG. 6 is a time chart illustrating a specific example of the control performed by the control device of the present embodiment; and

FIG. 7 is a time chart illustrating another specific example of the control performed by the control device of the present embodiment.

### DESCRIPTION OF EMBODIMENTS

Hereinafter, an embodiment according to the present disclosure will be described in detail below with reference to the drawings. Not all the features to be described in the following embodiments are necessarily essential for the present disclosure. Two or more features among a plurality of features to be described in the following embodiment may be combined as desired. In the following description, the same or similar elements are denoted by the same or similar reference numerals, and a description thereof may be omitted or simplified as appropriate.

### Example of Vehicle

First, a vehicle V including a control device (control device 10 to be described later), which is an embodiment of the present disclosure, will be described. The vehicle V of the present embodiment is an example of a vehicle in the present disclosure.

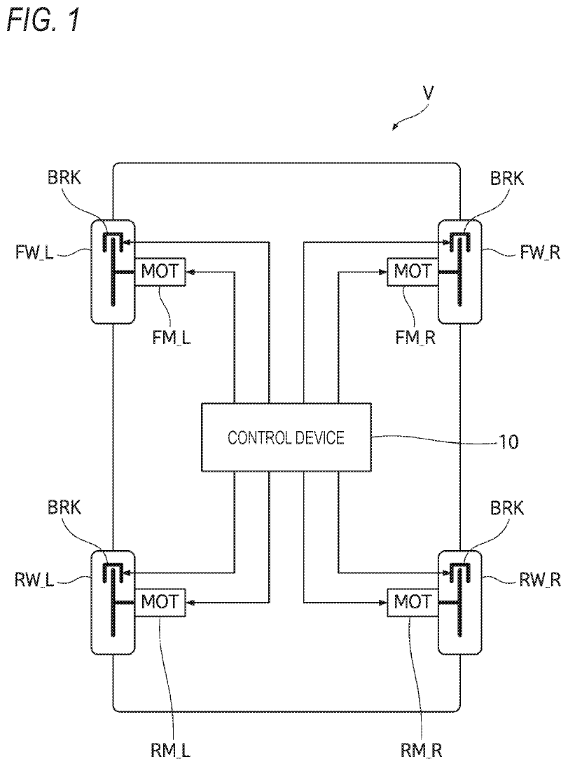

A vehicle V illustrated in FIG. 1 is a battery electric vehicle using an electric motor as a driving force source. In the example illustrated in FIG. 1, the vehicle V includes a motor FM_L, a motor FM_R, a motor RM_L, and a motor RM_R as electric motors that perform regenerative braking of wheels. The vehicle V includes a friction brake BRK as a braking device that performs friction braking of wheels, and the control device 10.

Each of the motors FM_L, FM_R, RM_L, and RM_R is a motor generator that also functions as a drive source of the vehicle V, and is constituted by, for example, an AC motor. Each of the motors FM_L, FM_R, RM_L, and RM_R operates as an electric motor by being supplied with electric power from a battery (not illustrated), and outputs power for the vehicle V to travel. Further, each of the motors FM_L, FM_R, RM_L, and RM_R can also operate as an electric generator for regeneration during braking of the vehicle V to perform power generation (so-called regenerative power generation). Electric power generated by the regenerative operation of each of the motors FM_L, FM_R, RM_L, and RM_R is supplied to the battery via, for example, a power conversion device (not illustrated) to charge the battery.

The motor FM_L is connected to a left front wheel FW_L, and an output of the motor FM_L is transmitted to the front wheel FW_L. Therefore, the motor FM_L drives the front wheel FW_L by performing a power running operation as an electric motor. The motor FM_L performs regenerative braking on the front wheel FW_L by performing a regenerative operation as an electric generator.

The motor FM_R is connected to a right front wheel FW_R, and an output of the motor FM_R is transmitted to the front wheel FW_R. Therefore, the motor FM_R drives the front wheel FW_R by performing a power running operation as an electric motor. The motor FM_R performs regenerative braking on the front wheel FW_R by performing a regenerative operation as an electric generator.

The motor RM_L is connected to a left rear wheel RW_L, and an output of the motor RM_L is transmitted to the rear wheel RW_L. Therefore, the motor RM_L drives the rear wheel RW_L by performing a power running operation as an electric motor. The motor RM_L performs regenerative braking on the rear wheel RW_L by performing a regenerative operation as an electric generator.

The motor RM_R is connected to a right rear wheel RW_R, and an output of the motor RM_R is transmitted to the rear wheel RW_R. Therefore, the motor RM_R drives the rear wheel RW_R by performing a power running operation as an electric motor. The motor RM_R performs regenerative braking on the rear wheel RW_R by performing a regenerative operation as an electric generator.

The friction brake BRK is provided for each of the wheels FW_L, FW_R, RW_L, and RW_R, and frictionally brakes each of the wheels FW_L, FW_R, RW_L, and RW_R. The friction brakes BRKs of the wheels FW_L, FW_R, RW_L, and RW_R can be independently controlled by the control device 10 to be described later. The friction brake BRK is, for example, a hydraulic brake.

The control device 10 is a device (computer) for integrally controlling the entire vehicle V, and is implemented by, for example, an electronic control unit (ECU) including a processor (not illustrated) that performs various types of calculation, a memory (not illustrated) that stores various types of information, and an interface (not illustrated) that controls input and output of data between inside and outside of the control device 10. The control device 10 may be implemented by one ECU or may be implemented by a plurality of ECUs.

### Example of Control Device

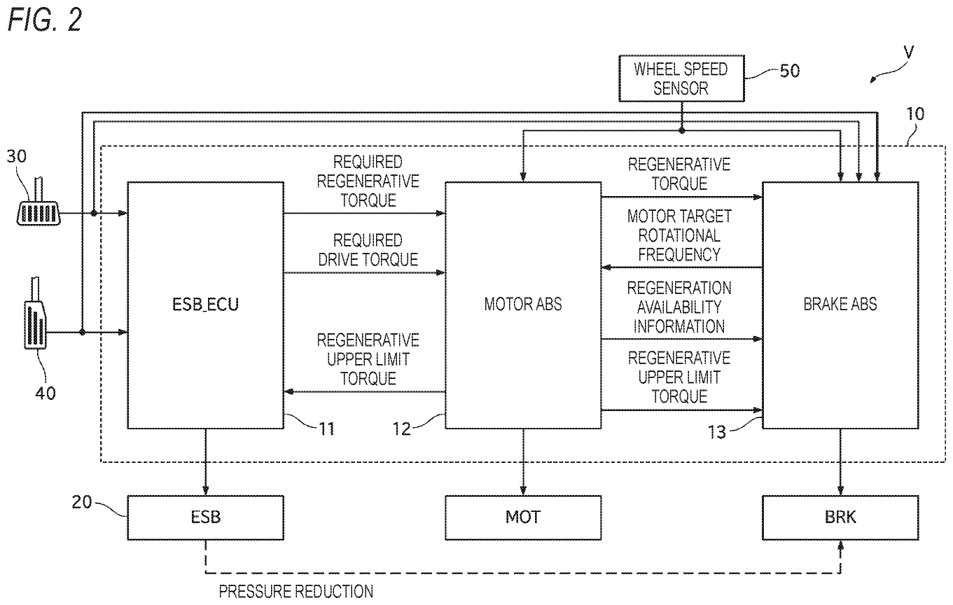

As illustrated in FIG. 2, the control device 10 includes, for example, an electric servo brake system (ESB_ECU) 11, a motor ABS (Anti-lock Braking System) 12, and a brake ABS 13.

The electric servo brake system 11 controls an electric servo brake (illustrated as “ESB”) 20 configured to reduce a hydraulic pressure (hereinafter, also referred to as “brake pressure”) of the friction brake BRK to generate a friction braking torque by the friction brake BRK.

Specifically, the electric servo brake system 11 derives and acquires a required deceleration based on a brake pedal stroke (hereinafter, also referred to as a “BRK stroke”) detected by a brake pedal sensor 30. For example, the electric servo brake system 11 may derive a required deceleration corresponding to a current BRK stroke with reference to a required deceleration map that is information for specifying the required deceleration corresponding to the BRK stroke. The electric servo brake system 11 derives a required regenerative torque based on the acquired required deceleration, and transmits a control signal related to the derived required regenerative torque to the motor ABS 12. The required regenerative torque can also be derived, for example, using a predetermined map or the like similarly to the required deceleration.

Further, when a regenerative torque of each of the motors FM_L, FM_R, RM_L, and RM_R reaches a predetermined regenerative upper limit torque, the electric servo brake system 11 causes the friction brake BRK to generate a friction braking torque by weakening the degree of reduction in the brake pressure by an electric servo brake 20. In other words, when the regenerative torque does not reach the regenerative upper limit torque (for example, when a braking force satisfying the required deceleration can be obtained only by the regenerative braking), the electric servo brake system 11 reduces, by the electric servo brake 20, the brake pressure in advance to a level where no friction braking torque is generated by the friction brake BRK.

The electric servo brake system 11 derives a required drive torque based on an accelerator pedal stroke (hereinafter, also referred to as an “AP stroke”) detected by an accelerator pedal sensor 40, and transmits a control signal related to the derived required drive torque to the motor ABS 12. The required drive torque can also be derived, for example, using a predetermined map or the like similarly to the required deceleration.

The motor ABS 12 controls each of the motors FM_L, FM_R, RM_L, and RM_R (illustrated as “MOT”), and performs ABS control using these motors. Specifically, the motor ABS 12 derives a vehicle speed that is a travel speed of the vehicle V and a slip rate (or a slip amount) based on a wheel speed or a motor rotational frequency detected by a wheel speed sensor 50, and detects a slip. Further, the motor ABS 12 monitors the regenerative torque of each of the motors FM_L, FM_R, RM_L, and RM_R, and when the regenerative torque reaches the regenerative upper limit torque, notifies the electric servo brake system 11 and the brake ABS 13 of the fact (for example, transmits a predetermined control signal).

The motor ABS 12 notifies the brake ABS 13 of the regenerative torque by transmitting a control signal related to the regenerative torque to the brake ABS 13. Further, the motor ABS 12 transmits a control signal related to regeneration availability information to the brake ABS 13. Here, the regeneration availability information is, for example, information indicating whether regeneration of each of the motors FM_L, FM_R, RM_L, and RM_R can be performed from hardware circumstances such as a state of charge (SOC) of the battery and a temperature of the battery or the power conversion device.

The brake ABS 13 controls the friction brake BRK of each of the wheels FW_L, FW_R, RW_L, and RW_R, and performs ABS control using these friction brakes BRKs. Specifically, the brake ABS 13 derives and acquires the required deceleration based on the BRK stroke detected by the brake pedal sensor 30. The brake ABS 13 derives a target friction braking torque from the required deceleration and the regenerative torque. For example, the brake ABS 13 derives, as the target friction braking torque, an amount for compensating for insufficiency of the regenerative torque alone insufficient to satisfy the required deceleration.

The brake ABS 13 derives a vehicle speed and a slip rate (or a slip amount) based on the wheel speed or the motor rotational frequency detected by the wheel speed sensor 50, and detects a slip. The brake ABS 13 performs the ABS control when the slip is detected. Further, for example, when driving force reduction such as traction control is required, the brake ABS 13 transmits a control signal related to a predetermined motor target rotational frequency to the motor ABS 12.

As described above, in the vehicle V, the brake pedal sensor 30 and the electric servo brake system 11 can function as a required deceleration acquisition unit that acquires a required deceleration. In the vehicle V, each of the wheel speed sensor 50, the motor ABS 12, and the brake ABS 13 can function as a wheel speed acquisition unit that acquires a wheel speed (that is, a rotational speed of a wheel).

The control device 10 is configured to be able to control a braking amount of friction braking by the friction brake BRK and a braking amount of regenerative braking by each of the motors FM_L, FM_R, RM_L, and RM_R based on the required deceleration, the wheel speed, and the slip amount (or the slip rate) by cooperation of the electric servo brake system 11, the motor ABS 12, and the brake ABS 13. Accordingly, the control device 10 can perform various controls such as slip control performed by changing the braking amount of the regenerative braking by each of the motors FM_L, FM_R, RM_L, and RM_R and slip control performed by changing the braking amount of the friction braking by the friction brake BRK of each of the wheels FW_L, FW_R, RW_L, and RW_R.

### Priority of Slip Control

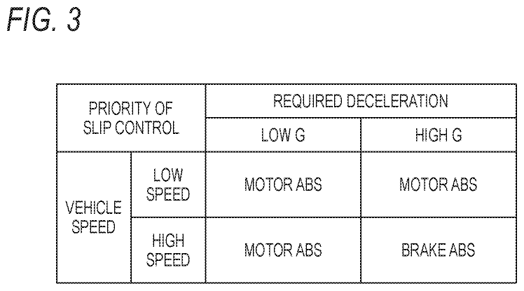

The control device 10 switches between the slip control performed by changing the braking amount of the regenerative braking and the slip control performed by changing the braking amount of the friction braking according to the vehicle speed and the required deceleration. The priority of each slip control in such cases is illustrated in FIG. 3.

As indicated by the entry “motor ABS” in both the column of “required deceleration ‘low G’ and vehicle speed ‘low speed’” and the column of “required deceleration ‘low G’ and vehicle speed ‘high speed’” in the table of FIG. 3, the control device 10 controls the braking amount by regenerative braking when the required deceleration is less than a predetermined deceleration, that is, “required deceleration ‘low G’”, and changes the braking amount of the regenerative braking to perform slip control when a slip occurs at the wheel during the regenerative braking. Specifically, in this case, a regenerative torque of the wheel in which the slip has occurred may be reduced.

That is, according to the control device 10, when the required deceleration is less than the predetermined deceleration, the slip control is performed by the regenerative braking. Therefore, a load on the friction brake BRK (that is, the braking device) of each of the wheels FW_L, FW_R, RW_L, and RW_R can be reduced as compared with the case where the slip control is performed by the friction braking even when the required deceleration is less than the predetermined deceleration. The predetermined deceleration may be set in advance by, for example, a manufacturer of the vehicle V.

As indicated by the entry “brake ABS” in the column of “required deceleration ‘high G’ and vehicle speed ‘high speed’” in the table of FIG. 3, the control device 10 controls the braking amount by the regenerative braking and the friction braking when the required deceleration is equal to or greater than the predetermined deceleration, that is, “required deceleration 'high G'” and the wheel speed is equal to or greater than a predetermined rotational speed, that is, “vehicle speed ‘high speed’”, and changes the braking amount of the friction braking to perform slip control when a slip occurs at the wheel during braking by the regenerative braking and the friction braking.

That is, according to the control device 10, when the required deceleration is equal to or greater than the predetermined deceleration and the wheel speed is equal to or greater than the predetermined rotational speed, the slip control is performed by the friction braking while the regenerative braking and the friction braking are used together. Therefore, when the required deceleration cannot be satisfied only by the regenerative braking, it is possible to reduce the slip that has occurred by the slip control by the friction braking while satisfying the required deceleration by the combination of the regenerative braking and the friction braking. Therefore, according to the control device 10, it is possible to appropriately control the regenerative braking and the friction braking of the wheel according to the slip amount of the wheel. The predetermined rotational speed may be set in advance by, for example, a manufacturer of the vehicle V.

As indicated by the entry “motor ABS” in the column of “required deceleration ‘high G’ and vehicle speed ‘low speed’” in the table of FIG. 3, the control device 10 controls the braking amount by the regenerative braking and the friction braking when the required deceleration is equal to or greater than the predetermined deceleration, that is, “required deceleration ‘high G’” and the wheel speed is less than the predetermined rotational speed, that is, “vehicle speed ‘low speed’”, and changes the braking amount of the regenerative braking to perform slip control when a slip occurs at the wheel during braking by the regenerative braking and the friction braking.

That is, according to the control device 10, when the required deceleration is equal to or greater than the predetermined deceleration and the wheel speed is less than the predetermined rotational speed, the slip control is performed by the regenerative braking while the regenerative braking and the friction braking are used together. Therefore, when the required deceleration cannot be satisfied only by the regenerative braking, it is possible to reduce the slip that has occurred by the slip control by the regenerative braking while satisfying the required deceleration by the combination of the regenerative braking and the friction braking. Therefore, according to the control device 10, it is possible to appropriately control the regenerative braking and the friction braking of the wheel according to the slip amount of the wheel.

### Example of Processing Related to Slip Control Performed by Control Device 10

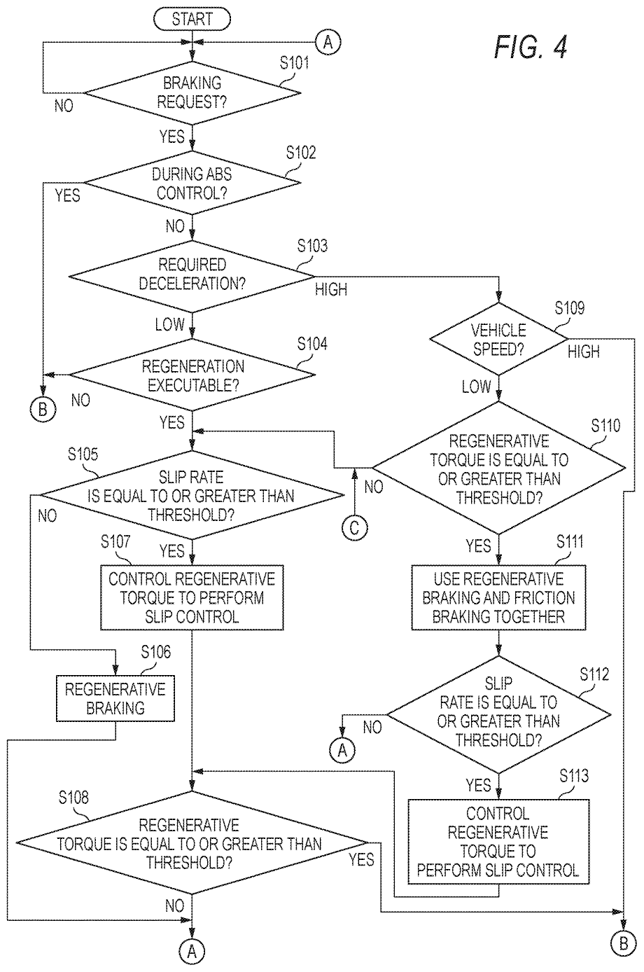

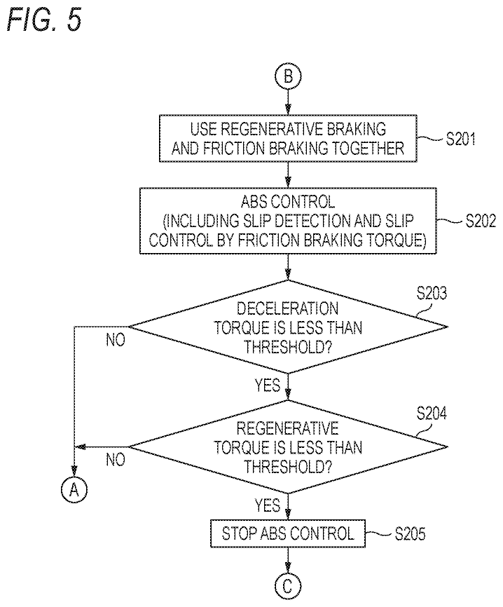

The flowcharts of FIGS. 4 and 5 illustrate a control flow of an example of processing related to slip control performed by the control device 10. First, in the flowchart of FIG. 4, the control device 10 determines whether there is a braking request (for example, depression of a brake pedal) in step S101. When there is no braking request and thus “NO” is determined in step S101, the control flow is returned without performing the processing of each subsequent step. On the other hand, when there is a braking request and thus “YES” is determined in step S101, the control flow proceeds to step S102.

In step S102, it is determined whether the ABS control is being performed, that is, whether the slip control is being performed. When the ABS control is not being performed and thus “NO” is determined in step S102, the control flow proceeds to step S103.

In step S103, the required deceleration is determined. Specifically, the control device 10 determines whether the required deceleration is less than a predetermined deceleration. The predetermined deceleration used in the processing of step S103 is predetermined as a threshold for determining the level of the magnitude of the required deceleration. When the required deceleration is less than the predetermined deceleration and thus “low” is determined in step S103, the control flow proceeds to step S104.

In step S104, it is determined whether regeneration can be performed. The control device 10 determines whether the regeneration of each of the motors FM_L, FM_R, RM_L, and RM_R can be performed based on, for example, the regeneration availability information described above. When the regeneration can be performed and thus “YES” is determined in step S104, the control flow proceeds to step S105.

In step S105, it is determined whether the slip rate is equal to or greater than a threshold. For example, the control device 10 determines that a slip has occurred when the slip rate derived based on the wheel speed is equal to or greater than a predetermined threshold. When the slip rate is less than the threshold, that is, no slip has occurred yet, and thus “NO” is determined in step S105, the control flow proceeds to step S106.

In step S106, the regenerative braking is performed. In this case, since the required deceleration is less than the predetermined deceleration, the control device 10 controls the braking amount by the regenerative braking of the motors FM_L, FM_R, RM_L, and RM_R. After the regenerative braking is performed in step S106, the control flow is returned.

On the other hand, when the slip rate is equal to or greater than the threshold, that is, the slip has occurred, and thus “YES” is determined in step S105, the control flow proceeds to step S107. In step S107, the regenerative torque is controlled to perform the slip control. That is, the control device 10 performs the slip control by changing the braking amount of the regenerative braking of each of the motors FM_L, FM_R, RM_L, and RM_R. After the slip control is performed by changing the braking amount of the regenerative braking in step S107, the control flow proceeds to step S108.

In step S108, it is determined whether the regenerative torque is equal to or greater than a threshold. Specifically, the control device 10 determines that the regenerative torque has reached the regenerative upper limit torque when the monitored regenerative torque is equal to or greater than a predetermined threshold. When the regenerative torque is less than the threshold, that is, the regenerative torque has not yet reached the regenerative upper limit torque, and thus “NO” is determined in step S108, the control flow is returned. On the other hand, when it is determined that the regenerative torque has reached the regenerative upper limit torque, the control flow proceeds to step S201 to be described later.

When the required deceleration is equal to or greater than the predetermined deceleration and thus “high” is determined in step S103 described above, the control flow proceeds to step S109. In step S109, the vehicle speed is determined. Specifically, the control device 10 determines whether the vehicle speed based on the wheel speed is a predetermined value. The predetermined value used in the processing of step S109 is predetermined as a threshold for determining the level of the magnitude of the vehicle speed. When the vehicle speed is less than the predetermined value and thus “low” is determined in step S109, the control flow proceeds to step S110.

In step S110, it is determined whether the regenerative torque is equal to or greater than a threshold. Specifically, the control device 10 determines that the regenerative torque has reached the regenerative upper limit torque when the monitored regenerative torque is equal to or greater than a predetermined threshold. When the regenerative torque is less than the threshold, that is, the regenerative torque has not yet reached the regenerative upper limit torque, and thus “NO” is determined in step S110, the control flow proceeds to step S105 described above, and the processing from step S105 onward is executed as described above.

On the other hand, when the regenerative torque is equal to or greater than the threshold, that is, the regenerative torque has reached the regenerative upper limit torque, and thus “YES” is determined in step S110, the control flow proceeds to step S111.

In step S111, the braking is performed using both regenerative braking and friction braking. In this case, since the required deceleration is equal to or greater than the predetermined deceleration and the vehicle speed (in other words, the wheel speed) is less than the predetermined value, the control device 10 controls the braking amount by both the regenerative braking of the motors FM_L, FM_R, RM_L, and RM_R and the friction braking of the friction brakes BRKs of the wheels FW_L, FW_R, RW_L, and RW_R.

Subsequently, in step S112, it is determined whether the slip rate is equal to or greater than a threshold. When the slip rate is less than the threshold, that is, no slip has occurred yet, and thus “NO” is determined in step S112, the control flow is returned without performing the subsequent steps.

On the other hand, when the slip rate is equal to or greater than the threshold, that is, the slip has occurred, and thus “YES” is determined in step S112, the control flow proceeds to step S113. In step S113, the regenerative torque is controlled to perform the slip control. That is, the control device 10 performs the slip control by changing the braking amount of the regenerative braking of each of the motors FM_L, FM_R, RM_L, and RM_R. After the slip control is performed by changing the braking amount of the regenerative braking in step S113, the control flow proceeds to step S108 described above, and the processing from step S108 onward is executed as described above.

On the other hand, when the ABS control is being performed and thus “YES” is determined in step S102, when the regeneration cannot be performed and thus “NO” is determined in step S104, or when the vehicle speed (in other words, the wheel speed) is equal to or greater than the predetermined value and thus “high” is determined in step S109, the control flow proceeds to step S201 illustrated in the flowchart of FIG. 5.

In step S201, the braking is performed using both regenerative braking and friction braking. In this case, the control device 10 controls the braking amount by both the regenerative braking of the motors FM_L, FM_R, RM_L, and RM_R and the friction braking of the friction brakes BRKs of the wheels FW_L, FW_R, RW_L, and RW_R. In this case, the control device 10 maintains the regenerative braking at a maximum braking force (for example, the regenerative torque at the regenerative upper limit torque) while controlling the braking amount of the friction braking.

According to the processing of step S201, while the braking amount by the friction braking is controlled, the regenerative braking is maintained at the maximum braking force, so that the braking amount by the friction braking required to satisfy the required deceleration is reduced, and the load on the friction brake BRK, that is, the braking device of each of the wheels FW_L, FW_R, RW_L, and RW_R can be reduced.

Subsequently, in step S202, the ABS control, that is, the slip control is performed. In this case, the control device 10 detects a slip (for example, determines whether the slip rate is equal to or greater than a threshold), and performs the slip control by the friction braking torque (that is, the slip control for changing the braking amount of the friction braking) when a slip is detected. Further, the control device 10 performs control so as not to perform the slip control by the regenerative torque (that is, the slip control for changing the braking amount of the regenerative braking) while performing the slip control by the friction braking torque. The control device 10 maintains the braking amount of the regenerative braking at the maximum braking force while performing the slip control by the friction braking torque due to the occurrence of the wheel slip.

According to the control of step S202, since the slip control by the regenerative torque is not performed during the execution of the slip control by the friction braking torque, it is possible to prevent the slip control by the regenerative torque and the slip control by the friction braking torque from occurring at the same time, and to simplify the control during the slip control. While the slip control by the friction braking torque is performed, the regenerative braking is maintained at the maximum braking force (that is, constant), so that the control of the slip control by the friction braking torque can be simplified as compared with a case where the braking amount by the regenerative braking fluctuates.

Subsequently, in step S203, it is determined whether a deceleration torque is equal to or less than a threshold. The threshold in this case is a deceleration upper limit torque, and is predetermined as a threshold for determining convergence of the slip. When the deceleration torque becomes equal to or less than the threshold, the control device 10 determines that the slip converges and the slip control ends. When the deceleration torque is larger than the threshold and thus “NO” is determined in step S203, the control flow returns to step S101 described above, and the processing from step S101 onward is executed as described above. On the other hand, when the deceleration torque is equal to or less than the threshold and thus “YES” is determined in step S203, the control flow proceeds to step S204.

In step S204, it is determined whether the regenerative torque is less than a threshold. When the regenerative torque is less than the threshold, that is, the regenerative torque is less than the regenerative upper limit torque, “YES” is determined in step S204, the control flow proceeds to step S205, the slip control by the friction braking torque is stopped, and the processing from step S105 onward is executed as described above.

On the other hand, when the regenerative torque is equal to or greater than the threshold and thus “NO” is determined in step S204, the control flow returns to step S101 described above, and the processing from step S101 onward is executed as described above.

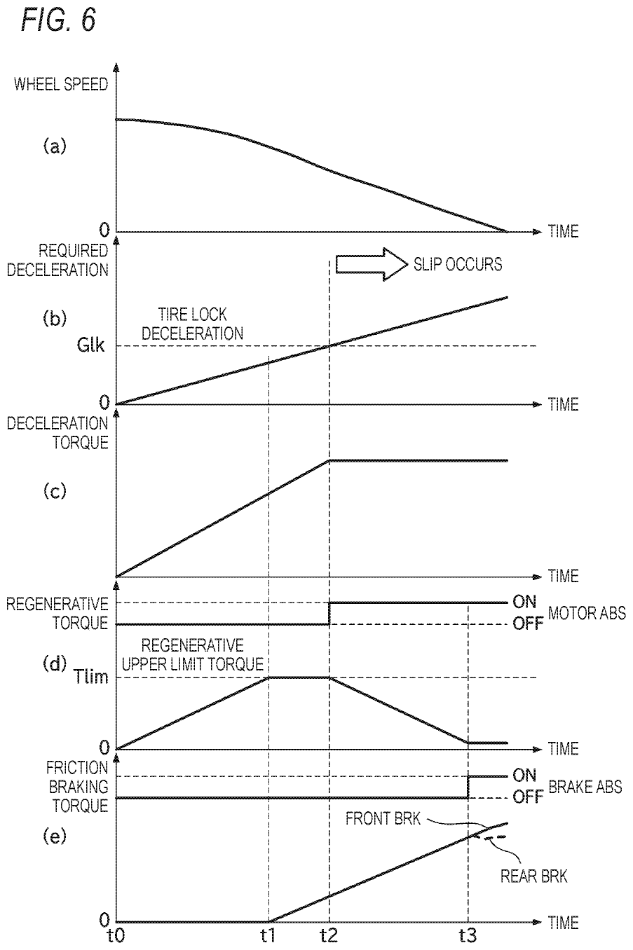

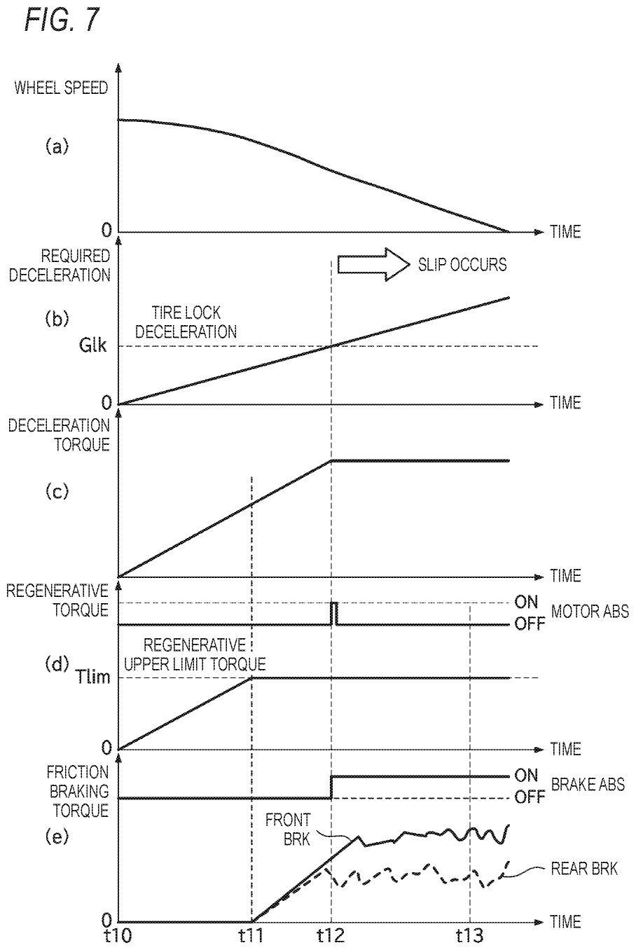

FIGS. 6 and 7 are time charts illustrating behaviors of the regenerative torque, the friction braking torque, and the like when the control illustrated in the flowcharts of FIGS. 4 and 5 is performed. In the example illustrated in the time chart of FIG. 6, the control device 10 performs braking by the regenerative torque from time t0 to time t1, thereby decelerating the vehicle V (that is, the wheel speed). When the regenerative torque reaches a regenerative upper limit torque Tlim at time t1, the control device 10 starts braking by the friction braking torque. Thereafter, at time t2, for example, since the deceleration torque exceeds a tire lock deceleration Glk, the control device 10 detects the occurrence of the slip. At the same time, the slip control (illustrated as “motor ABS”) by the regenerative torque is started. At time t3, the control device 10 starts the slip control (illustrated as “brake ABS”) by the friction braking torque.

In the example illustrated in the time chart of FIG. 7, the control device 10 performs braking by the regenerative torque from time t10 to time t11, thereby decelerating the vehicle V (that is, the wheel speed). When the regenerative torque reaches the regenerative upper limit torque Tlim at time t11, the control device 10 maintains the regenerative torque at the maximum (that is, the regenerative upper limit torque Tlim). At the same time, the braking by the friction braking torque is started. Thereafter, at time t12, for example, since the deceleration torque exceeds the tire lock deceleration Glk, the control device 10 starts the slip control (brake ABS) by the friction braking torque when the occurrence of the slip is detected. In this case, the control device 10 does not perform the slip control (motor ABS) by the regenerative torque. That is, while the slip control for changing the braking amount of the friction braking is performed, the slip control for changing the braking amount of the regenerative braking is not performed.

Although the embodiment of the present disclosure has been described, it goes without saying that the present disclosure is not limited to such an example. It is apparent that those skilled in the art can conceive of various modifications and alterations within the scope described in the claims, and it is understood that such modifications and alterations naturally fall within the technical scope of the present disclosure.

For example, in the above-described embodiment, the left front wheel FW_L, the right front wheel FW_R, the left rear wheel RW_L, and the right rear wheel RW_R are braked and driven by the motors FM_L, FM_R, RM_L, and RM_R, respectively, but the present disclosure is not limited thereto. For example, the vehicle V may be a two-wheel drive vehicle in which the left front wheel FW_L and the right front wheel FW_R, or the left rear wheel RW_L and the right rear wheel RW_R are drive wheels. In this case, the vehicle V may include only motors corresponding to the drive wheels among the motors FM_L, FM_R, RM_L, and RM_R. For example, when only two wheels, that is, the left front wheel FW_L and the right front wheel FW_R are drive wheels, the vehicle V may include only the motors FM_L and FM_R among the motors FM_L, FM_R, RM_L, and RM_R. When only the two wheels, that is, the left rear wheel RW_L and the right rear wheel RW_R are drive wheels, the vehicle V may include only the motors RM_L and RM_R among the motors FM_L, FM_R, RM_L, and RM_R.

For example, in the above-described embodiment, the example in which the vehicle V in the present disclosure is a battery electric vehicle using an electric motor as a driving force source has been described, but the present disclosure is not limited thereto. For example, the vehicle V in the present disclosure may be a hybrid electrical vehicle equipped with not only an electric motor but also an internal combustion engine.

In addition, the constituent elements in the embodiments described above may be freely combined without departing from the gist of the disclosure.

In the present description and the like, at least the following matters are described. Although corresponding constituent elements or the like in the above embodiment are illustrated in parentheses, the present disclosure is not limited thereto.
(1) A vehicle including:
an electric motor (motors FM_L, FM_R, RM_L, and RM_R) configured to perform regenerative braking of a wheel (left front wheel FW_L, right front wheel FW_R, left rear wheel RW_L, and right rear wheel RW_R.);
a braking device (friction brake BRK) configured to perform friction braking of the wheel (FW_L, FW_R, RW_L, and RW_R);
a required deceleration acquirer (brake pedal sensor 30) configured to acquire a required deceleration of the wheel;
a wheel speed acquirer (wheel speed sensor 50) configured to acquire a rotational speed of the wheel; and
a control device (control device 10) configured to control braking amounts of the electric motor and the braking device, in which the control device is configured to perform braking of the wheel based on the required deceleration, the rotational speed, and a slip amount of the wheel.

According to (1), the braking amounts of the braking device and the electric motor can be controlled based on the required deceleration, the rotational speed of the wheel, and the slip amount, and thus it is possible to appropriately control the regenerative braking and the friction braking of the wheel according to the slip amount of the wheel while satisfying the required deceleration.
(2) The vehicle according to (1), in which
the control device is configured to
   control a braking amount by the regenerative braking in response to the required deceleration being less than a predetermined deceleration, and

perform slip control by changing a braking amount of the regenerative braking in response to an occurrence of a slip at the wheel during the regenerative braking.

According to (2), when the required deceleration is less than the predetermined deceleration, the slip control is performed by the regenerative braking, and thus it is possible to prevent an increase in load on the braking device (that is, the friction braking) as compared with the case where the slip control is performed by the friction braking.
(3) The vehicle according to (1), in which
the control device is configured to
   control a braking amount by the regenerative braking and the friction braking in response to the required deceleration being equal to or greater than a predetermined deceleration and in response to the rotational speed being equal to or greater than a predetermined rotational speed, and
   perform slip control by changing a braking amount of the friction braking in response to an occurrence of slip at the wheel during braking by the regenerative braking and the friction braking.

According to (3), when the required deceleration is equal to or greater than the predetermined deceleration and the rotational speed of the wheel is equal to or greater than the predetermined rotational speed, the slip control is performed by the friction braking while the regenerative braking and the friction braking are used together, and thus it is possible to appropriately control the regenerative braking and the friction braking of the wheel according to the slip amount of the wheel while satisfying the required deceleration.
(4) The vehicle according to (1), in which
the control device is configured to
   control a braking amount by the regenerative braking and the friction braking in response to the required deceleration being equal to or greater than a predetermined deceleration and in response to the rotational speed being less than a predetermined rotational speed, and
   perform slip control by changing a braking amount of the regenerative braking in response to an occurrence of a slip at the wheel during braking by the regenerative braking and the friction braking.

According to (4), when the required deceleration is equal to or greater than the predetermined deceleration and the rotational speed of the wheel is less than the predetermined rotational speed, the slip control is performed by the regenerative braking while the regenerative braking and the friction braking are used together, and thus it is possible to appropriately control the regenerative braking and the friction braking of the wheel according to the slip amount of the wheel while satisfying the required deceleration.
(5) The vehicle according to (4), in which
the control device is configured not to perform slip control for changing a braking amount of the friction braking while performing the slip control by changing the braking amount of the regenerative braking due to the occurrence of the slip at the wheel.

According to (5), the slip control for changing the braking amount of the friction braking is not performed during the slip control by the regenerative braking, and thus it is possible to prevent the slip control by the regenerative braking and the slip control by the friction braking from occurring at the same time, and to simplify the control during the slip control.
(6) The vehicle according to (5), in which
the control device is configured not to perform slip control for changing a braking amount of the regenerative braking while performing the slip control for changing the braking amount of the friction braking.

According to (6), the slip control for changing the braking amount of the regenerative braking is not performed during the slip control by the friction braking, and thus it is possible to prevent the slip control by the regenerative braking and the slip control by the friction braking from occurring at the same time, and to simplify the control during the slip control.
(7) The vehicle according to (3), in which
the control device is configured to maintain the regenerative braking at a maximum braking force while controlling the braking amount of the friction braking.

According to (7), by maintaining the regenerative braking at the maximum braking force while the braking amount by the friction braking is controlled, the braking amount by the friction braking required to satisfy the required deceleration can be reduced, and the load on the braking device (that is, the friction braking) can be reduced.
(8) The vehicle according to (3), in which
the control device is configured to maintain a braking amount of the regenerative braking at a maximum braking force while performing the slip control by changing the braking amount of the friction braking due to the occurrence of the slip at the wheel.

According to (8), by maintaining the regenerative braking at the maximum braking force (that is, constant) while performing the slip control by changing the braking amount of the friction braking, it is possible to simplify the control during the slip control by the friction braking as compared with a case where the braking amount by the regenerative braking fluctuates.

What is claimed is:

1. A vehicle comprising:
an electric motor configured to perform regenerative braking of a wheel;
a braking device configured to perform friction braking of the wheel;
a required deceleration acquirer configured to acquire a required deceleration of the wheel;
a wheel speed acquirer configured to acquire a rotational speed of the wheel; and
a control device configured to control braking amounts of the electric motor and the braking device, wherein the control device is configured to perform braking of the wheel based on the required deceleration, the rotational speed, and a slip amount of the wheel.

2. The vehicle according to claim 1, wherein
the control device is configured to
control a braking amount by the regenerative braking in response to the required deceleration being less than a predetermined deceleration, and
perform slip control by changing a braking amount of the regenerative braking in response to an occurrence of a slip at the wheel during the regenerative braking.

3. The vehicle according to claim 1, wherein
the control device is configured to
control a braking amount by the regenerative braking and the friction braking in response to the required deceleration being equal to or greater than a predetermined deceleration and in response to the rotational speed being equal to or greater than a predetermined rotational speed, and
perform slip control by changing a braking amount of the friction braking in response to an occurrence of slip at the wheel during braking by the regenerative braking and the friction braking.

4. The vehicle according to claim 1, wherein
the control device is configured to
control a braking amount by the regenerative braking and the friction braking in response to the required deceleration being equal to or greater than a predetermined deceleration and in response to the rotational speed being less than a predetermined rotational speed, and
perform slip control by changing a braking amount of the regenerative braking in response to an occurrence of a slip at the wheel during braking by the regenerative braking and the friction braking.

5. The vehicle according to claim 4, wherein
the control device is configured not to perform slip control for changing a braking amount of the friction braking while performing the slip control by changing the braking amount of the regenerative braking due to the occurrence of the slip at the wheel.

6. The vehicle according to claim 5, wherein
the control device is configured not to perform slip control for changing a braking amount of the regenerative braking while performing the slip control for changing the braking amount of the friction braking.

7. The vehicle according to claim 3, wherein
the control device is configured to maintain the regenerative braking at a maximum braking force while controlling the braking amount of the friction braking.

8. The vehicle according to claim 3, wherein
the control device is configured to maintain a braking amount of the regenerative braking at a maximum braking force while performing the slip control by changing the braking amount of the friction braking due to the occurrence of the slip at the wheel.
